(19) United States
(12) Patent Application Publication
(10) Pub. No.: US 2009/0148116 A1
(43) Pub. Date: Jun. 11, 2009

(54) COMMUNICATION APPARATUS FOR COMMUNICATION BETWEEN HOUSING SLOTS, WIRING CHANGE UNIT AND WIRING METHOD

(75) Inventors: Shigeyuki Yanagimachi, Tokyo (JP); Takashi Yoshikawa, Tokyo (JP); Junichi Sasaki, Tokyo (JP); Kazuhiko Kurata, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Minato-ku, Tokyo (JP)

(21) Appl. No.: 11/719,649

(22) PCT Filed: Nov. 18, 2005
(86) PCT No.: PCT/JP05/21263

§ 371 Date: May 17, 2007

(30) Foreign Application Priority Data
Nov. 18, 2004 (JP) 2004-334867

(51) Int. Cl. G02B 6/00

(52) U.S. Cl. 385/135

(57) ABSTRACT

An intra-housing optical communication system includes card slots 61 to 64 and at least a concentrate slot and conducts the optical communication between the slots, wherein the optical wires between the card slots are connected by using an optical fiber sheet or the like to simplify the wiring and reduce the size of the housing. The concentrate slots include an optical wiring change unit 6 for changing the form of connection between the card slots, thereby making it possible to easily change the form of connection to the desired shape (mesh, ring, etc.). Also, the optical terminals of the optical connectors are shared by a plurality of the slots and thus made available for use among the optical connectors.

### TECHNICAL FIELD

This invention relates to a communication apparatus for communication between housing slots, a wiring change unit and a wiring method.

### BACKGROUND ART

Generally, an optical communication apparatus uses the configuration in which a plurality of line cards are inserted in a housing and interconnected on the back plane. Methods of laying optical fibers on the back plane include a method in which an optical connector having a single core or two cores is mounted on the back plane and a plurality of optical fibers are wired one by one with a patch cord and a method in which a multi-core connector having 4 to 24 cores is mounted on the back plane and a plurality of optical fibers are collectively wired by using a ribbon fiber having a bunch of optical fibers in a ribbon. With the increase in the number of wires, however, the wiring work is complicated while at the same time posing the disadvantage of an increased space for disposing extra length parts of the wires.

In view of this, recently, the wiring work has been simplified and the space for wiring has been decreased by use of the multi-core connector and an optical fiber sheet in which the optical wires on an optical back plane are collectively formed (Patent Document 1). The optical fiber sheet includes such a structure that a plurality of optical fiber cores are sandwiched between thin sheets, and the wiring length is predetermined in accordance with the size of the housing, thereby eliminating the extra space and thus saving the space.

The techniques related to this invention include a concentrator for connecting a plurality of changing units described in Patent Document 2, a concentrator used with the optical communication network described in Patent Document 3, and an apparatus for processing the electrical signal and the optical signal described in Patent Document 4.
Patent Document 1: Japanese Patent Application Laid-open No. 2003-121697
Patent Document 2: Japanese Patent Application Laid-open No. 2002-217924
Patent Document 3: Japanese Patent Application Laid-open No. 07-107112
Patent Document 4: Japanese Patent Application Laid-open No. 11-113033

### DISCLOSURE OF THE INVENTION

The first disadvantage is that in the conventional optical communication apparatus having a plurality of card slots on a housing for conducting the communication between the card slots by optical transmission, the form of connecting the card slots cannot be easily changed. The reason is that the optical wiring between the card slots are fixedly connected by using an optical fiber sheet or the like to simplify the wiring and reduce the housing size. Specifically, once the optical fiber sheet is set, it is difficult to change the assemblage of the optical fibers to the desired form of connection between the card slots.

The second disadvantage is that in the conventional optical communication system having a plurality of card slots mounted on a housing for conducting the communication between the card slots by optical transmission, the number of wires connected between the card slots cannot be easily changed. Specifically, the communication band assigned to the card slots is fixed and cannot be changed flexibly. The reason is that the optical wires between the card slots are fixedly connected by using an optical fiber sheet or the like to simplify the wiring and reduce the housing size. Specifically, once the optical fiber sheet is set, it is difficult to change the number of optical fibers connected to the card slots.

The object of this invention is to provide an intra-housing optical communication apparatus, a wiring change unit and a wiring method, for a large-capacity intra-housing optical communication apparatus for conducting the communication between the slots of the housing by optical transmission, wherein the form of connecting the card slots and the number of the optical fibers assigned to the card slots can be flexibly changed.

According to this invention, there is provided a communication apparatus comprising a housing including one or a plurality of card slots including one or a plurality of connectors, and one or a plurality of concentrate slots including one or a plurality of connectors for collecting wires from the card slots, wherein a wiring change unit for setting the form of connection between the collected wires is inserted into the concentrate slots.

Also, according to this invention, there is provided a communication apparatus comprising a housing including one or a plurality of card slots each including one or a plurality of connectors, and one or a plurality of concentrate slots including one or a plurality of connectors for collecting the wires from the card slots, wherein one or a plurality of the terminals of the connector are shared in one card slot or among a plurality of the card slots.

According to this invention, there is provided a wiring change unit for collecting the wires from one or a plurality of card slots each including one or a plurality of connectors on a housing and setting the form of connecting the collected wires, wherein the wiring change unit is inserted into one or a plurality of concentrate slots each including one or a plurality of the connectors on the housing.

According to this invention, there is provided a wiring method for a communication apparatus comprising a housing including one or a plurality of card slots each including one or a plurality of connectors, and one or a plurality of concentrate slots each including one or a plurality of the connectors for collecting the wires from the card slots, wherein the wiring method comprises inserting a wiring change unit for setting the form of connection between the collected wires into the concentrate slots.

According to this invention, there is provided a wiring method for a communication apparatus comprising a housing including one or a plurality of card slots each including one or a plurality of connectors, and one or a plurality of concentrate slots each including one or a plurality of the connectors for collecting the wires from the card slots, wherein the wiring method comprises sharing one or a plurality of the terminals of the connector, in one card slot or among a plurality of the card slots.

### EFFECTS OF THE INVENTION

According to this invention, the form of connecting the card slots can be changed to star, mesh, ring, etc. simply by replacing the wiring change unit mounted on the concentrate slot without replacing the wires arranged in advance.

The reason is that the desired connection (star, mesh, ring, etc.) can be realized by appropriately selecting (changing) the connection (form) of the wiring change unit and connecting it to the collected wires.

Also, according to this invention, the communication band of each card slot can be flexibly changed by slot.

The reason is that the number of wires from the card slots to the concentrate slots can be freely changed between adjacent card slots by sharing one or a plurality of terminals of a connector in one card slot or among a plurality of card slots.

### BRIEF DESCRIPTION OF THE DRAWINGS

FIG. 1 is a diagram showing the appearance of an intra-housing optical communication system according to an embodiment of the invention;

FIG. 2 is a sectional view of an intra-housing optical communication system according to an embodiment of the invention;

FIG. 3 is a diagram showing the appearance of an optical back plane as taken from the card surface according to an embodiment of the invention;

FIG. 4 is a diagram showing the appearance of an optical back plane as taken from the back of the housing according to an embodiment of the invention;

FIG. 5 is an optical wiring diagram of an optical fiber sheet according to an embodiment of the invention;

FIG. 6 is a diagram for explaining the optical wiring change unit according to an embodiment of the invention;

FIG. 7 is a diagram for explaining the optical wiring change unit according to a second embodiment of the invention;

FIG. 8 is a diagram for explaining the optical wiring change unit according to a third embodiment of the invention;

FIG. 9 is a block diagram showing the operation of an embodiment of the invention;

FIG. 10 is a diagram showing the appearance of the optical back plane as taken from the card surface according to a fourth embodiment of the invention;

FIG. 11 is a diagram showing the appearance of the optical back plane as taken from the back of the housing according to the fourth embodiment of the invention;

FIG. 12 is a diagram showing the appearance of the optical back plane as taken from the card surface according to the fourth embodiment of the invention;

FIG. 13 is a diagram showing an example of the case including four line cards in total and two optical wiring change cards in total;

FIGS. 14A and 14B are diagrams showing the configuration of an optical jumper;

FIG. 15 is a diagram showing the flow for determining the optical wiring change card to be inserted;

FIG. 16 is a diagram showing the flow for executing the process of sharing the optical connectors according to the same embodiment; and

FIG. 17 is a block diagram showing the operation of a comparative example.

### DESCRIPTION OF REFERENCE NUMERALS

1 Optical communication housing
12 Line card
13 Switch card or optical wiring change unit
14 External input/output port of line card
15 External communication path from external input/output port of line card
211 Optical connector mounted on line card and switch card
212 Power supply connector mounted on line card and switch card
213 Electric connector mounted on line card and switch card
22 Optical back plane
221 Optical connector mounted on optical back plane
222 Optical fiber sheet mounted on optical back plane
23 Electric back plane mounted on optical communication housing
231 Electric connector mounted on electric back plane
232 Power supply connector mounted on electric back plane
31 Line card slot mounted on optical communication housing
32 Concentrate slot mounted on optical communication housing
41 Optical fiber sheet mounted on optical back plane
51 Optical fiber in optical fiber sheet
6 Optical wiring change unit (optical wiring change card)
61 Line card slot A mounted on optical communication housing
62 Line card slot B mounted on optical communication housing
63 Line card slot C mounted on optical communication housing
64 Line card slot D mounted on optical communication housing
65 Optical wire
7 Optical wiring change unit (optical wiring change card)
71 Optical wire
8 Optical wiring change unit (optical wiring change card)
81 Optical wire
82 Optical switch mounted on optical wiring change unit
91 Line card inserted in optical communication housing
911 Input/output connector of line card
912 Transceiver of line card
913 Signal analyzer of line card
914 Optical transceiver of line card
915 Optical connector for back plane of line card
916 Switch of line card
92 Switch card inserted in optical communication housing
921 Optical connector for back plane of switch card
922 Optical transceiver of switch card
923 Switch of switch card
924 Signal analyzer of switch card
93 Optical back plane mounted on optical communication housing
10a Optical jumper
10b Optical terminal of optical connector
11a Short optical cable

### BEST MODE FOR CARRYING OUT THE INVENTION

Next, the best mode of the invention is explained in detail with reference to the drawings.

### [Embodiment 1]

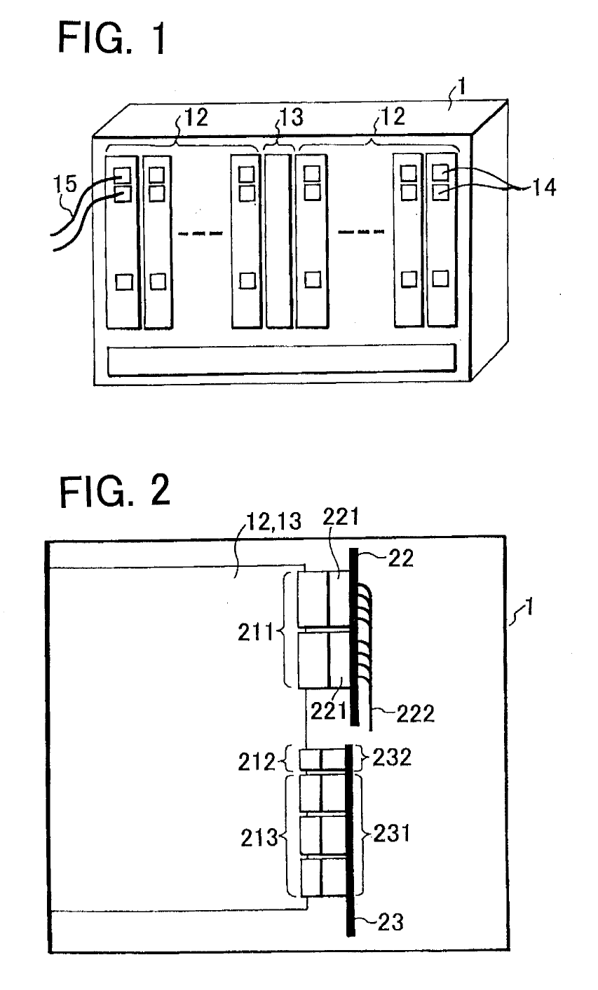

FIG. 1 is a diagram showing an overall configuration of an intra-housing optical communication system according to the invention, and FIG. 2 is a sectional view of a housing. The intra-housing optical communication system according to this invention includes a housing 1, a plurality of modular units (typically, line cards 12, with reference to which the description is made below) and optical wiring change card 13 as one or a plurality of optical wiring change units. Reference numeral 14 designates external input/output ports of the line card 12, and reference numeral 15 designates external communication paths (optical fiber, etc.) from the input/output ports 14 of the line card 12.

Next, the internal structure of the housing 1 is explained with reference to FIG. 2. The housing 1 has mounted thereon an optical back plane 22 and an electric back plane 23, and further, one or a plurality of optical connectors 221 are arranged on the optical back plane 22. The optical connectors 221 are mounted in opposed relation to optical connectors 211 on the line card 12 inserted into card slots and mounted in opposed relation to the optical connectors 211 on the optical wiring change cards 13 inserted into the concentrate slots. In similar fashion, one or a plurality of power supply connectors 232 and one or a plurality of electric connectors 231 are mounted in opposed relation to power supply connectors 212 on the line cards 12 and electric connectors 213 on the switch cards 13, respectively. Upon insertion of the line cards 12 and the optical wiring cards 13 into the housing 1, the optical connectors 211 are connected to the optical connectors 221, the power supply connectors 212 to the power supply connectors 232 and the electric connectors 213 to the electric connectors 231.

For example, the optical connection between the slots is established through the optical fibers wired on an optical fiber sheet 222 connected to the optical connectors 221 mounted on the optical back plane 22. Also, though not shown, an electric pattern wiring is formed on the electric back plane 23, and the slots are electrically wired to each other along the pattern.

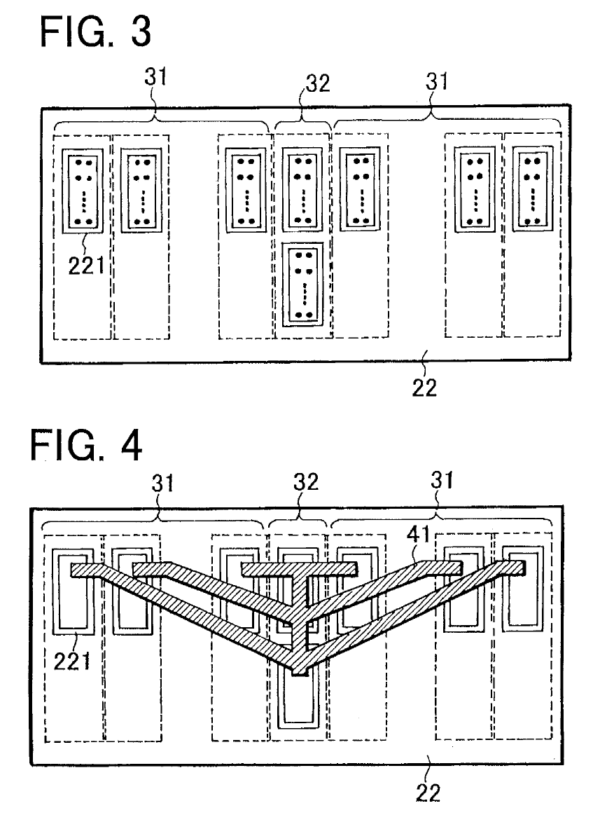

Next, the structure of the optical back plane 22 is explained with reference to FIGS. 3 and 4. FIG. 3 is a view (hereinafter referred to as the front view) of the optical back plane 22 as taken from the line cards. The optical back plane 22 has a plurality of line card slots 31 and one or a plurality of concentrate slots 32 (although only one concentrate slot is shown in FIGS. 3 and 4, a plurality of them can be arranged). The line card slots 31 have each mounted thereon one or a plurality of optical connectors 221 (one optical connectors 221 is shown in FIGS. 3 and 4), and the concentrate slot 32 has mounted thereon one or a plurality of optical connectors 221 (two optical connectors 221 are shown in FIGS. 3 and 4). Also, FIG. 4 is a view (hereinafter referred to as the rear view) of the optical back plane 22 taken from the back of the housing. The optical connectors 221 mounted on the line card slots 31 of the optical back plane 22 are connected in star form by using an optical fiber sheet 41 and the optical connectors 221 mounted on the concentrate slot 32. The optical fiber sheet 41 has such a structure that a plurality of optical fibers are sandwitched between thin sheets, and optical fibers are collected by multi-core connector. As compared with the conventional method of connecting the optical fibers one by one with a thick patch cord with a film, therefore, the wiring is simplified while at the same time reducing the wiring space. Also, the connection by the optical fiber sheet may be fixed.

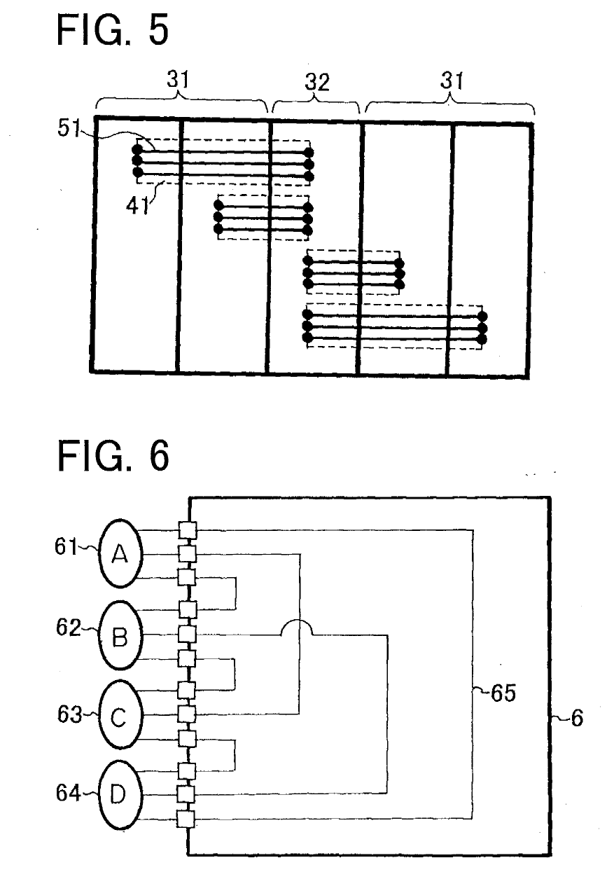

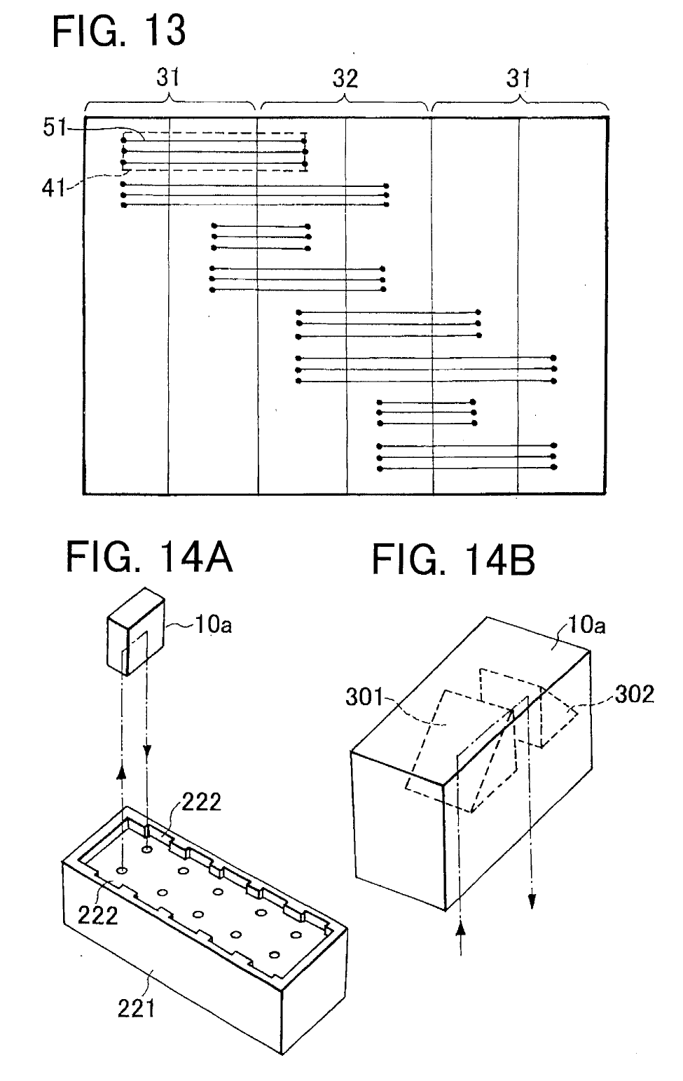

Next, the connection between the line card slots and the concentrate slots is explained in detail with reference to FIG. 5. In the drawing, to simplify the explanation, four line card slots and one concentrate slot are shown. The line card slots 31 and the concentrate slot 32 are connected to each other in star form by the optical fiber sheets 41 with the concentrate slot 32 forming an apex. The number of optical fibers 51 between each line card slot 31 and the concentrate slot 32 is given as n×(m−1) or more, where “m” (“m” is natural number of 2 or more) is the total number of line cards (card slots) and “n” (“n” is natural number of 1 or more) is the total number of the optical wiring change cards (concentrate slots). According to this embodiment, m=4 and n=1, and therefore, the number of the optical fibers 51 is three (3=1×(4−1)) or more. According to this embodiment, to simplify the explanation, the number of the line card slots is set to four and the number of the concentrate slot to one. With an increased number of both the line card slots and the concentrate slots, however, the number of the optical fibers can be calculated by using the equation mentioned above. In the case where the number of the line cards is set to six and the number of the optical wiring change cards is set to two, for example, the number of the optical fibers 51 between each line card slot 31 and the concentrate slot 32 is given as ten (10=2×(6−1)). FIG. 13 shows an example of the case in which the total number of the line cards is set four and the total number of the optical wiring change cards is set to two. In this case, the number of the optical fibers between each line card slot 31 and the concentrate slot 32 is six.

As described above, the wires are connected in tree (star) form with the concentrate slot as an apex, and the number of the wires between the card slots and the concentrate slot is set to n×(m−1) or more, where “m” (“m” is natural number of 2 or more) is the total number of the card slots and “n” (“n” is natural number of 1 or more) is the total number of the concentrate slot. By thus inserting the optical wiring change cards (wiring change units) into the concentrate slot, the card slots can be interconnected in various forms including mesh and ring. The mesh is defined as the form of connecting all the card slots to each other.

Next, the optical wiring change cards inserted into the concentrate slot 32 are explained with reference to FIG. 6. In FIG. 6, four line cards are designated by A to D each in a circle (61 to 64) for convenience of explanation. Also, the optical connection between the concentrate slot 32 and the line card slots 31 is established, as described above with reference to FIG. 5, by connecting the optical connector on the concentrate slot 32 and the optical connector on each card slot 31 through three optical lines. As a result, the optical wiring change card 6 inserted into the concentrate slot 32 is connected with each line card (A to D) by three optical lines. Under this condition of optical connection, the optical wiring change card 6 is so configured that, as shown in FIG. 6, three optical wires 65 are connected to the line card slots other than their own. The line card slot A (61), for example, is connected to each of the line card slots B to D (62 to 64).

In the configuration described above, by inserting the optical changing cards having the function of a center switch into the concentrate slot 32, the line card slots 31 are connected in star form with the center switch as an apex without changing the optical connection between the concentrate slot 32 and the line card slots 31. Also, by inserting the optical wiring change cards 6 into the concentrate slot 31, the line card slots 31 can be connected in mesh form without changing the optical connection between the concentrate slot 32 and the line card slots 31.

In the case where the wiring change units for setting the form of connecting the collected wires to each other are mounted on the concentrate slot in this way, the firm of connection of the card slot or between the card slots can be changed freely as desired without replacing the wires.

### (Explanation of Operation)

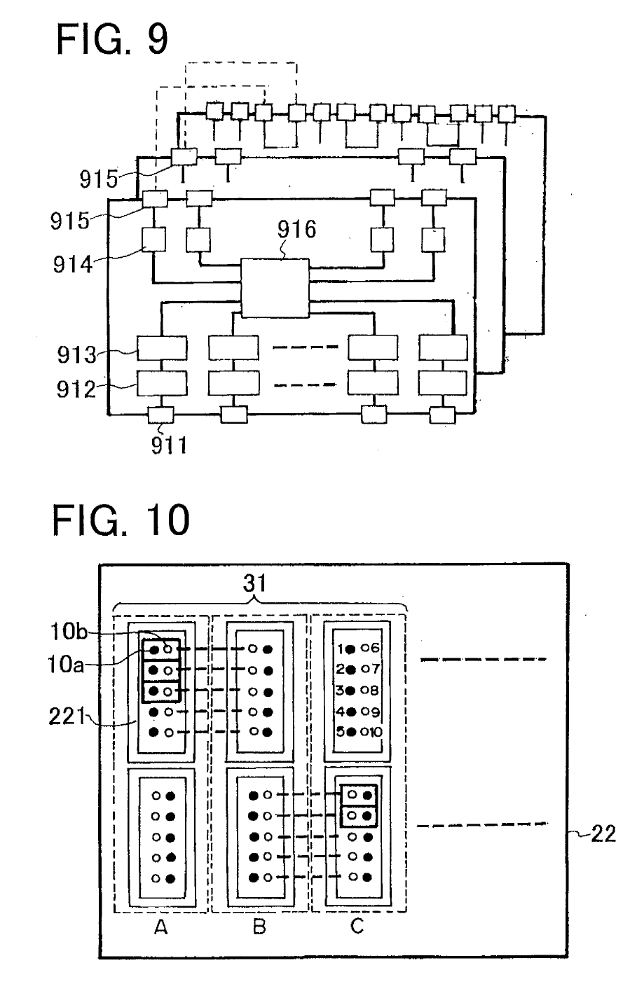

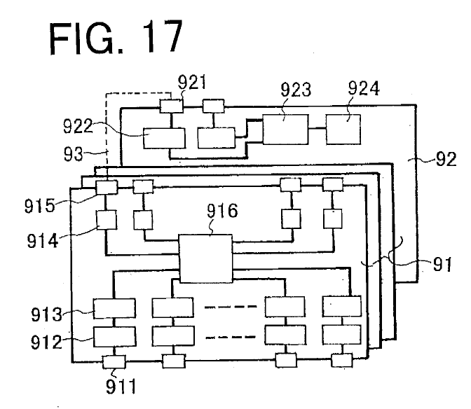

With reference to FIG. 9, the operation of this embodiment is explained. According to this embodiment, the optical wiring change cards are inserted into the concentrate slot. For comparative explanation of this embodiment, the configuration with switch card 92 inserted into the concentrate slot is explained with reference to FIG. 17.

In FIG. 17, line cards 91 are connected in star form with the center switch 92 as an apex. The signal input to a plurality of the line cards 91 from an external communication path through an input/output connector 911 is received by transceiver 912. The signal thus received is sent to an analyzer 913, and after being subjected to analysis of the header information and the error check, transferred to a switch 916 mounted on the line cards 91. The header information include, written therein, the information such as the sender address and the destination address which determine the route of the signal. Based on these information, the state of the switch 916 mounted on the line cards 91 is switched.

In the case where the destination is located within the same line card, the switch 916 is turned to the packet analyzer 913 having the address port, and sent out to the external communication path through the analyzer 913, the transceiver 912 and the input/output connector 911.

In the case where the output port is another line card, on the other hand, the signal is sent to an optical transceiver 914 through the switch 916 mounted on the line cards 91, and after being converted into an optical signal, sent to an optical transceiver 922 of the switch card through an optical connector 915 for the back plane of the line cards, optical connection 93 and an optical connector 921 for the back plane of the switch card 92. In the optical transceiver 922 of the switch card, the optical signal is converted into an electrical signal, and transferred to a switch 923 mounted on the switch card. An analyzer 924 of the switch 923 searches for the switching destination from the header information of the signal transmitted and transfers the signal to the optical transceiver 922 connected to the desired other line card. The signal, after being converted from the electrical signal to the optical signal again in the optical transceiver 922, is transferred to the optical transceiver 914 of another line card through the optical connector 921 for the back plane of the switch card, the optical connection 93 and the optical connector 915 for the back plane of another line card. The signal sent to another line card 91, after being converted into an electrical signal in the optical transceiver 915, turned by the switch 916 to the analyzer 913 connected with the desired output port, and sent out to the external communication path through the analyzer 913, the transceiver 912 and the input/output connector 911. In this case, the line card supplied with a first signal is different from the line card which outputs the signal at the end.

Next, the operation of the embodiment in which the optical wiring change card 6 (FIG. 6) is mounted in place of the switch card on the concentrate slot 92 is explained with reference to FIG. 9. The same component members as those in FIG. 17 are designated by the same reference numerals, respectively. In this case, the transfer operation in the same line card, not through the optical wiring change card 6, is similar to the transfer operation using the center switch, and therefore not described, and the explanation will be limited only to the case in which the input line card and the output line card are different from each other. According to this embodiment, each line card 91 is connected in mesh form. As explained with reference to FIG. 6, the input port and the output port are connected in one-to-one relation in the optical wiring change card 6, and therefore, the line card which a signal is output is predetermined by the input port.

In the case where the destination of the signal input to a certain line card is another line card, the switch 916 mounted in the line card transmits a signal to the optical transceiver 914. The optical transceiver 914 is coupled to the line card having the desired output port through the optical wiring change card 6. In the optical transceiver 914, after the electrical signal is converted to an optical signal, the signal is sent to the optical wiring change card 6 through the optical connector 915 for the back plane of the line card, the optical connection 93 and the optical connector 921 for the back plane of the optical wiring change card. The input port and the output port of the optical wiring change card 6 are optically connected simply in one-to-one relation, and therefore, no dynamic operation is performed. Thus, the transfer signal is sent to the optical transceiver 914 of another line card 91 having the desired output port through the optical connector 921 for the back plane of the optical wiring change card 6, the optical connection 93 and the optical connector 915 for the back plane of another line card.

The signal sent to another line card 91, after being converted into an electrical signal in the optical transceiver 914, is switched by the switch 916 to the analyzer 913 connected with the desired output port, and sent out to the external communication path through the analyzer 913, the transceiver 912 and the input/output connector 911.

According to this embodiment, by inserting the optical wiring change card in place of the switch card, the form of connection between the card slots can be changed freely to the desired shape without replacing the optical wire.

[Embodiment 2]

A second embodiment is explained below and different from the previously described embodiment in the configuration of the optical wiring change card constituting an optical wiring change unit. Therefore, only the optical wiring change card is explained below.

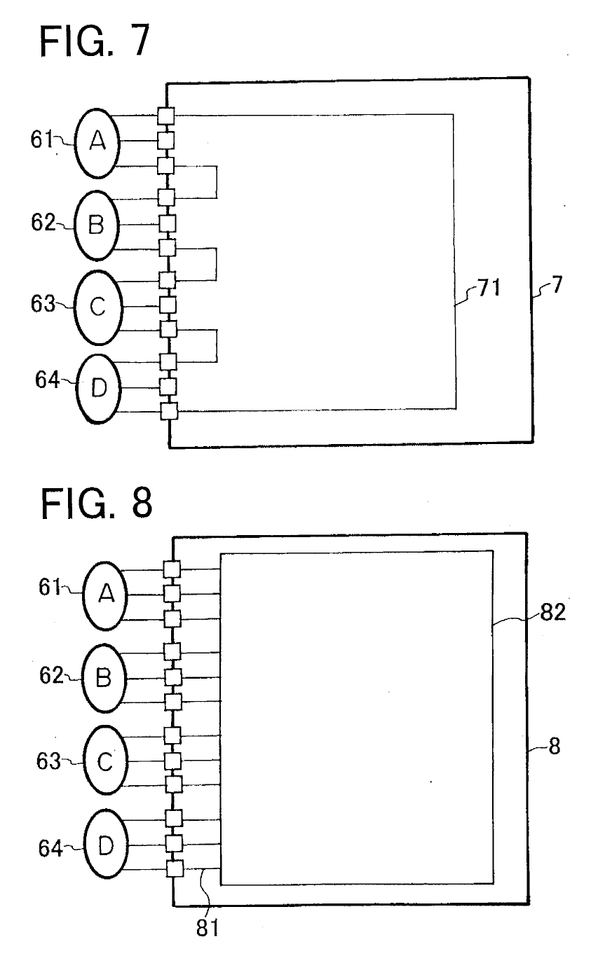

FIG. 7 is a diagram showing the configuration according to the second embodiment of the invention. Similarly to the first embodiment, the line card slots A to D (61 to 64) are each connected, through three optical lines, to the optical wiring change card 7. each line card slot is connected to an adjacent line card slot through optical wires 71 by using two out of the three optical wires. For example, the line card slot A (61) is connected to the line card slot B (62). Similarly, the line card slot B (62) is connected to the line card slot C (63), the line card slot C (63) is connected to the line card slot D (64), and the line card slot D (64) is connected to the line card slot A (61).

By inserting the optical wiring change card 7 into the concentrate slot 32, the form of connection between the line card slots can be set in the form of ring without changing the optical connection between the concentrate slot 32 and the line card slots 31.

### (Explanation of Operation)

Next, the operation of the second embodiment is explained. The second embodiment is different from the first embodiment only in that the optical wiring change card 6 in FIG. 9 is replaced by the optical wiring change card 7, and therefore, an explanation is given with reference to FIG. 9. The transfer operation in the same line card is not through the optical wiring change card, and therefore, an explanation is given only about a case in which the input line card and the output line card are different from each other. According to the second embodiment, the line cards 91 are connected in ring. As explained with reference to FIG. 7, the input port and the output port are connected in one-to-one relation in the optical wiring change card 7, and therefore, the line card which a signal is output is determined in advance by the input port.

In the case where the destination of a signal input to a given line card is another line card, the switch 916 mounted in the line card transmits a signal to the optical transceiver 914 coupled to the line card having the desired output port through the optical wiring change card 7. In the optical transceiver 914, after the electrical signal is converted into an optical signal, the resulting signal is sent to the optical wiring change card 7 through the optical connector 915 for the back plane of the line card, the optical connection 93 and the optical connector 921 for the back plane of the optical wiring change card 7. The input port and the output port of the optical wiring change unit 7 are connected simply in one-to-one relation to each other, and therefore, no dynamic operation is performed. Thus, the transfer signal is sent to the optical transceiver 914 of another line card having the desired output port through the optical connector 921 for the back plane of the optical wiring change card 7, the optical back plane 93 and the optical connector 915 for the back plane of another line card.

The signal sent to another line card 91, after being converted into an electrical signal in the optical transceiver 914, is switched by the switch 916 to the analyzer 913 connected with the desired output port, and sent out to the external communication path through the analyzer 913, the transceiver 912 and the input/output connector 911. Incidentally, the form of connection that can be realized by using the optical wiring change card 7 is a ring, and therefore, in order to output the input signal to the destination line card, the signal may be passed through the optical wiring change card 7 a plurality of times. Even in such a case, the signal flow described above is similar.

[Embodiment 3]

A third embodiment is explained below and different from the above-mentioned embodiments in the configuration of the optical wiring change card constituting the optical wiring change unit. Therefore, only the optical wiring change card is explained below.

FIG. 8 is a diagram showing the configuration according to the third embodiment of the invention. Each of the line card slots A to D (61 to 64) is connected through three optical lines 81 to the optical wiring change unit 8. The optical wiring change card 8 is so configured that each set of three optical wires 81 is connected to the optical switch 82. The optical switch is a matrix switch of 12×12, in which the connection between input ports can be set freely. For example, the mesh connection according to the above-mentioned embodiments and the ring connection according to the second embodiment can be realized by changing the setting of the optical switch. Also, the connection is not limited to these forms.

As long as the optical wiring change card is configured of an optical switch in this way, the connection form between the card slots can be changed to the desired form by setting the port connection of the optical switch from outside without replacing the optical wiring change card.

### (Explanation of Operation)

Next, the operation of the third embodiment is explained. The third embodiment is different from the first embodiment only in that the optical wiring change card 6 is replaced by the optical wiring change card 8 as shown in FIG. 9. The explanation will be made, therefore, with reference to FIG. 9. The transfer operation in the same line card is not through the optical wiring change card 8, and therefore, an explanation is given only about a case in which the input line card and the output line card are different from each other. According to the third embodiment, each line card is connected by an optical switch mounted on the optical wiring change unit. As explained with reference to FIG. 8, the optical wiring change card 8 has mounted an optical switch thereon, and the optical wires can be dynamically changed. Thus, various forms of connection including mesh and ring can be realized. A specific form of connection is set in advance.

In the case where the destination of the signal input to a given line card is another line card, the switch 916 mounted in the line card transmits a signal to the optical transceiver 914 coupled to the line card having the desired output port through the optical wiring change card 8 having an optical switch. In the optical transceiver 914, the electrical signal is converted into an optical signal, after which the signal is sent to the optical wiring change unit 8 through the optical connector 915 for the back plane of the line card, the optical connection 93 and the optical connector 921 for the back plane of the optical wiring change card 8 having the optical switch mounted thereon. The input port and the output port of the optical wiring change unit 8 are optically connected simply in one-to-one relation to each other through the optical switch, and therefore, no dynamic operation is performed. Thus, the transfer signal is sent to the optical transceiver 914 of another line card having the desired output port through the optical connector 921 for the back plane of the optical wiring change card 8, the optical connection 93 and the optical connector 915 for the back plane of another line card.

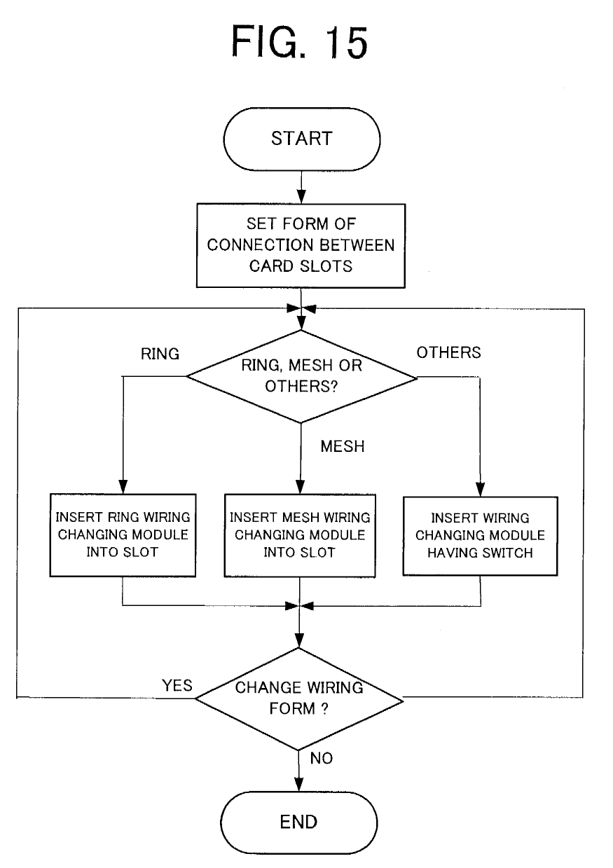

The signal sent to another line card 91, after being converted into an electrical signal in the optical transceiver 914, turned by the switch 916 to the analyzer 913 connected with the desired output port and sent to the external communication path through the analyzer 913, the transceiver 912 and the input/output connector 911. In each of the embodiments described above, each of the optical wiring change cards 6, 7 and 8 can be inserted arbitrarily into the concentrate slot, and also, whenever the form of wiring is required to be changed, the optical wiring change card in the concentrate slot can be replaced to the desired optical wiring change card. The related flow is shown in FIG. 15.

### [Embodiment 4]

The embodiments explained above refer to a case in which only one concentrate slot 32 is included. As shown in FIG. 13, however, a plurality of concentrate slots 32 may be included, as described above. In an embodiment having a plurality of concentrate slots, the optical wiring change card in the same or different form of connection may be inserted into each concentrate slot 32.

In the case where optical wiring change cards of different forms of connection are inserted, a plurality of forms of connection can be set (prepared) between the line cards in a single housing. By setting (preparing) a plurality of forms of connection in this way, the freedom of selecting the form of connection between the line cards is increased, and a more efficient connection made possible.

In the case where the optical wiring change cards in the same form of connection are inserted, on the other hand, the wiring redundancy can be secured. In the case where a fault occurs in a given connection, therefore, the fault can be easily repaired by using another connection.

### [Embodiment 5]

Next, a fifth embodiment is explained in detail with reference to the drawings.

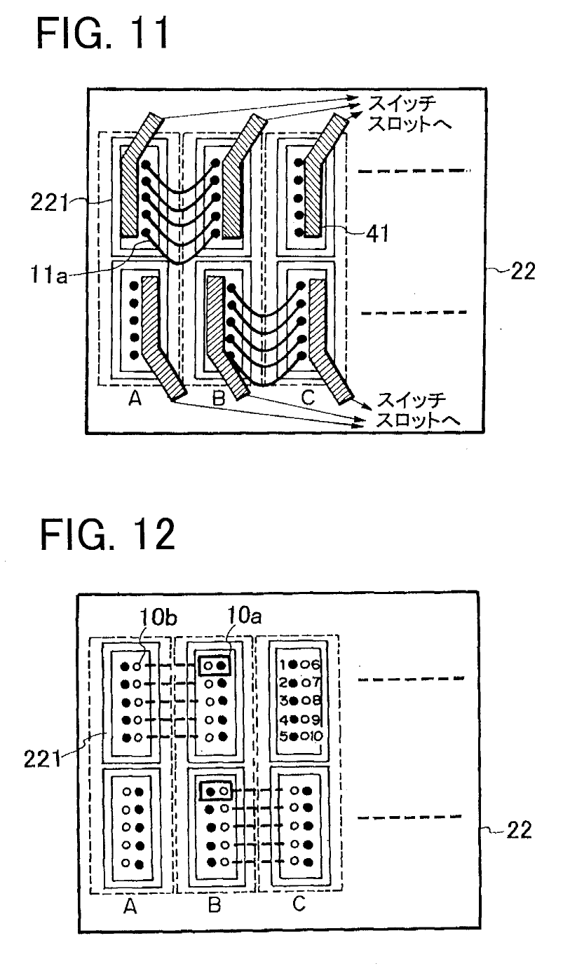

FIGS. 10 to 12 are diagrams showing the configuration of a fifth embodiment of the invention. In the drawings, only the line card slots 31 are shown. FIG. 10 shows the appearance (front surface) of the optical back plane 22 as viewed from the card side, which is configured of one or a plurality of optical connectors 221 and an optical jumper 10a described later. Also, FIG. 11 shows the appearance (back surface) of the optical back plane as viewed from the back of the housing, wherein an optical fiber sheet 41 and an optical short cable 11a are mounted on the back of the optical back plane 22. According to this embodiment, the optical connectors 221, though arranged in two columns and five rows to simplify the explanation, may be arranged in arbitrary number of rows and columns. Also, the optical terminal numbers are set at 1 to 10 from upper left. On the back surface, one of the two columns of the optical terminals 10b of the optical connector 221 is connected to one column of the adjacent slot by a short optical cable 11a. The optical terminals 10b in the other column are connected to a concentrate slot (not shown) through the optical fiber sheet 41. As viewed from the front, the short optical fibers 11a are designated by dotted lines in the drawing, and the optical terminals indicated by white circles are connected between adjacent slots, while the optical terminals indicated by black circles are connected to the concentrate slot through the optical fibers 41. Specifically, a total of 10 optical terminals 10b including five on the upper optical connector side and five on the lower optical connector side are connected with the concentrate slot 31 between the line card slots and the concentrate slot 31, while the remaining five optical terminals 10b on the upper optical connector side and the five optical terminals 10b on the lower optical connector side are shared between the adjacent slots.

Next, two examples of the configuration are explained with reference to FIGS. 10 and 12. In FIG. 10, the optical jumper 10a constituting the optical connecting element connects between optical terminals 1 and 6, between optical terminals 2 and 7, and between optical terminals 3 and 8 of the upper optical connector of the slot A on the one hand, and connects between optical terminals 1 and 6 and between optical terminals 2 and 7 of the lower optical connector of the slot C on the other hand.

Specifically, the optical terminals 1, 2 and 3 of the upper optical connector of the slot B are connected to the concentrate slot through optical terminal pairs 6-1, 7-2 and 8-3 of the upper optical connector of the slot A. Similarly, the optical terminals 6, 7 of the lower optical connector of the slot B are connected to the concentrate slot through the optical terminal pairs 6-1, 7-2 of the lower optical connector of the slot C. Specifically, in slot B, in addition to the ten (black circles) optical terminals originally connected to the concentrate slot, three and two optical terminals are connected to the concentrate slot through the slots A and C, respectively, with the result that fifteen optical terminals are connected to the concentrate slot. Also, with the increase in the number of connections between the slot B and the concentrate slot, the number of connections between the slot A and the concentrate slot is reduced by three and to seven, and the number of connections between the slot C and the concentrate slot is reduced by two and to eight. Assuming that the band per optical terminal is 10 Gbps, the concentrate slot A is 7 Gbps, the slot B is 15 Gbps and the slot C is 8 Gbps.

FIG. 12 shows another example of connection. The optical jumpers 10a connect the optical terminals 1 and 6 of the upper optical connector of the slot B, and the optical terminals 1 and 6 of the lower optical connector of the slot B. Specifically, the optical terminal 6 of the upper optical connector of the slot A is connected to the concentrate slot through the optical terminal pair 6-1 of the upper optical connector of the slot B. Similarly, the optical terminal 1 of the lower optical connector of the slot C is connected to the concentrate slot through the optical terminal pair 6-1 of the lower optical connector of the slot B. Specifically, in slot A, in addition to the original ten (black circles) connections to the concentrate slot, the optical connections with the concentrate slot are increased by one through the slot B, while the optical connections of the slot C to the concentrate slot is increased by one through the slot B. Also, the optical connections between the slot B and the concentrate slot is reduced by two and to eight. Assuming that the band per optical terminal is 10 Gbps, the concentrate slot A is 11 Gbps, the slot B is 8 Gbps and the slot C is 11 Gbps.

Specifically, each line card slot 31 shares the optical terminals with the adjacent line card slot, so that the number of optical connections between the line card slots and the concentrate slot can be made variable. According to this embodiment, the number of optical connections with the concentrate slot in two line card slots can be made variable in the range of 0 to 20. That is, assuming that the band per optical terminal is 10 Gbps, the number of optical connections with the concentrate slot in two line card slots can be made variable in the range of 0 to 20 Gbps.

The optical jumper 10a, as shown in FIG. 14B, for example, has a configuration in which two triangular prisms 301, 302 are opposed to each other, and can be inserted into the groove 222 of the optical connector 221. The light from an optical terminal of the optical connector 222 is reflected on one triangular prism 301 and enters the other triangular prism 302. The light reflected from the other triangular prism 302 enters the other optical terminal, with the result that the adjacent optical terminals are optically connected to each other. In place of the triangular prism, a reflection mirror may be used. Though the optical connectors are shared by adjacent slots in column according to this embodiment, may be shared in another form according to the invention.

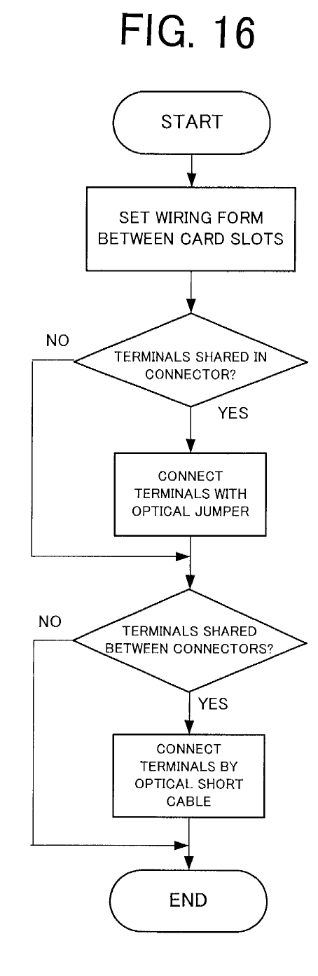

The sharing according to this embodiment is realized by the process flow shown in FIG. 16. Specifically, the wiring form is set between the card slots, and it is determined whether the terminals in the connector are shared or not. Upon determination that they are shared, the optical jumper is used for connection of the terminals in the connector. Next, it is determined whether the terminals are shared or not between the connector. Upon determination that they are shared, the optical short cable is used for connection of the terminals. The connection by the optical jumper and the connection by the optical short cable can be reversed in order.

### (Explanation of Operation)

Next, the operation of the fourth embodiment is explained with reference to the example of connection shown in FIG. 10. In the line card B, the optical terminals 1 to 3, 6 to 10 of the upper optical connector and the optical terminals 1 to 7 of the lower optical connector are used as output terminals. In the line card A, on the other hand, the optical terminals 4 to 5 of the upper optical connector and the optical terminals 6 to 10 of the lower optical connector are used as output terminals. Similarly, in the line card C, the optical terminals 1 to 5 of the upper optical connector and the optical terminals 8 to 10 of the lower optical connector are used as output terminals. Now, the signal flow between the line card B and the concentrate slot is explained. The optical signal output from the line card B is output from the slot B through the optical terminals 1 to 3, 6 to 10 of the upper optical connector and the optical terminals 1 to 7 of the lower optical connector. The optical signals output from the optical terminals 6 to 10 (black circles) of the upper optical connector and the optical terminals 1 to 5 (black circles) of the lower optical connector are transferred directly to the concentrate slot through the optical fiber 41. The optical signals output from the optical terminals 1 to 3 (white circles) of the upper optical connector, on the other hand, are output to the optical fiber 41 from the optical terminals 1 to 3 of the upper optical connector of the slot A through the short cable 11a, the optical terminals 6 to 8 of the upper optical connector of the slot A and the optical jumper 10b, and further transferred to the concentrate slot. Also, the optical signals output from the optical terminals 6 and 7 (white circles) of the lower optical connector are output to the optical fiber 41 from the optical terminals 6 and 7 of the lower optical connector of the slot C through the short cable 11a, the optical terminals 1 and 2 of the lower optical connector of the slot C and the optical jumper 10b, and further transferred to the concentrate slot.

As explained above, by sharing one or a plurality of terminals of an optical connector in one card slot or among a plurality of card slots, the communication band can be made available between the card slots sharing the optical connector, thereby making it possible to flexibly change the communication band assigned to the card slots.

Although the optical connection is explained in the foregoing embodiments, a similar configuration can be employed also in the case where the card slots are electrically connected fixedly to each other.

1-15. (canceled)

16. A communication apparatus comprising a housing including one or a plurality of card slots each including one or a plurality of connectors, and one or a plurality of concentrate slots each including one or a plurality of connectors for collecting wires from the card slots,
wherein a wiring change unit for sctting the form of connection between the collected wires is inserted into the concentrate slots, and the form of connection is specified by the internal wiring of the wiring change unit which is set without analyzing the information of the signal input to the wiring change unit.

17. The communication apparatus according to claim 16, wherein the wires are connected in the form of a tree with the concentrate slots as an apex, and the number of wires between the card slots and the concentrate slots is not less than n×(m−1), where “m” (“m” being natural number of two or more) is the total number of the card slots and “n” (“n” being natural number of one or more) is the total number of the concentrate slots.

18. The communication apparatus according to claim 16, wherein the wiring change unit connects the card slots in the form of mesh.

19. The communication apparatus according to claim 16, wherein the wiring change unit connects the card slots in the form of ring.

20. The communication apparatus according to claim 16, wherein the wiring change unit connects the card slots by using a switch.

21. A communication apparatus comprising a housing including one or a plurality of card slots each including one or a plurality of connectors, and one or a plurality of concentrate slots each including one or a plurality connectors for collecting the wires from the card slots,
wherein one or a plurality of the terminals of the connector of the card slots are shared in one card slot or among a plurality of the card slots by connecting the terminals ol the card slots to each other.

22. The communication apparatus according to claim 21, wherein the connectors each include two or more columns of the terminals, one of the columns of the terminals is shared by adjacent card slots, and the other column of the terminals is connected to the concentrate slot.

23. The communication apparatus according to claim 21, wherein the connectors are optical connectors, and the share of one or a plurality of the terminals in one card slot or among a plurality of the card slots is carried out by optically connecting the terminals with an optical connecting element for bringing the light from one terminal to another terminal.

24. The communication apparatus according to claim 22, wherein the connectors are optical connectors, and the share of one column of the terminals between adjacent card slots is carried out by optically connecting the terminals with an optical connecting element for bringing the light from one terminal to another terminal.

25. The communication apparatus according to any one of claims 16 to 24, wherein the wires are collected fixedly.

26. The communication apparatus according to any one of claims 16 to 20 and 25, wherein the wiring change unit connects the collected wires in a desired form, and the desired form of connection realizes a desired form of connection between the card slots by coupling to the collected wires.

27. A wiring change unit for collecting the wires from one or a plurality of card slots each including one or a plurality of connectors on a housing and setting the form of connecting the collected wires, the wiring change unit being inserted into one or a plurality of concentrate slots each including one or a plurality of the connectors on the housing,
wherein the form of connection is specified by the internal wiring which is set without analyzing the information of the input signals.

28. A wiring method for a communication apparatus comprising a housing including one or a plurality of card slots each including one or a plurality of connectors, and one or a plurality of concentrate slots each including one or a plurality of the connectors for collecting the wires from the card slots,
the wiring method comprising inserting a wiring change unit for setting the form of connection between the collected wires into the concentrate slots,
wherein the form of connection is specified by the internal wiring of the wiring change unit which is set without analyzing the information of the signals input to the wiring change unit.

29. The wiring method according to claim 28, wherein the form of connection between the collected wires is changed by replacing the wiring change unit.

30. A wiring method for a communication apparatus comprising a housing including one or a plurality of card slots each including one or a plurality of connectors, and one or a plurality of concentrate slots each including one or a plurality ol the connectors for collecting the wires from the card slots, the wiring method comprising sharing one or a plurality of the terminals of the connector of the card slots, in one card slot or among a plurality of the card slots by connecting the terminals of the card slots to each other.
